(19) United States
(12) Patent Application Publication
(10) Pub. No.: US 2017/0080554 A1
(43) Pub. Date: Mar. 23, 2017

(54) HYDRAULIC HAMMER ASSEMBLY

(71) Applicant: Caterpillar Inc., Peoria, IL (US)

(72) Inventors: Cody T. Moore, Waco, TX (US); Dennis W. Tang, Hewitt, TX (US)

(73) Assignee: Caterpillar Inc., Peoria, IL (US)

(21) Appl. No.: 15/365,001

(22) Filed: Nov. 30, 2016

(51) Int. Cl. B25D 9/04; B33Y 80/00; E02F 3/96

(52) U.S. Cl. CPC B25D 9/04; E02F 3/966; B33Y 80/00; B25D 2217/0019

(57) ABSTRACT

A hydraulic hammer assembly is disclosed. The hydraulic hammer assembly includes a piston and an accumulator membrane disposed external and coaxial to the piston The hydraulic hammer assembly includes a sleeve disposed coaxially between the piston and the accumulator membrane. The sleeve defines a first set of holes in an outer surface thereof to receive hydraulic fluid. The sleeve defines a second set of holes in an inner surface thereof and located distant from the first set of holes along a longitudinal axis of the sleeve. The sleeve defines a plurality of passages within a wall, and extending along the longitudinal axis. Each of the plurality of passages includes a porous medium to increase surface area of each of the plurality of passages. The increased surface area of each of the plurality of passages increases a rate of dissipation of heat from the wall of the sleeve.

### TECHNICAL FIELD

The present disclosure relates to a hydraulic hammer assembly, and more particularly relates to a sleeve of the hydraulic hammer assembly.

### BACKGROUND

Machines, such as excavators, are provided with hydraulic hammers to break large and hard objects into smaller pieces to assist in easy disposal of such objects from one location to another. Typically, the hydraulic hammers include a reciprocating piston disposed within a sleeve for breaking large and hard objects. During the operation of a hydraulic hammer, reciprocation of the piston causes heat generation within the hydraulic hammer. The sleeve is generally embodied as a two-piece component with thick metal sections. As such, the sleeve tends to absorb heat generated during operation of the hydraulic hammer and, by virtue of the thickness, tends to retain the absorbed heat for long durations. Such heat retention may affect efficiency of the hydraulic hammer and may cause premature failure of the sleeve.

U.S. Pat. No. 6,722,454, hereinafter referred to as ‘the '454 patent’, describes a device for drilling holes, including a drill bit having drilling or breaking surface, a drill rod for introducing a cooling fluid into the drill bit, and a sheath pipe which defines a hollow space between the drill rod and the inside of the sheath pipe. In a drilling position, the sheath pipe is situated at a distance from a rear side of the drill bit facing away from the breaking surface and the drill bit can be introduced into a rinsing position for the hollow space between the sheath pipe and the drill rod with its rear side resting on the front end of the sheath pipe facing towards the drill bit. However, the '454 patent fails to disclose ways to achieve dissipation of heat generated during drilling.

### SUMMARY OF THE DISCLOSURE

In an aspect of the present disclosure, a hydraulic hammer assembly is provided. The hydraulic hammer assembly includes a piston and an accumulator membrane disposed external and coaxial to the piston. The hydraulic hammer assembly further includes a sleeve disposed coaxially between the piston and the accumulator membrane. The sleeve defines a first set of holes in an outer surface thereof to receive hydraulic fluid. The sleeve further defines a second set of holes in an inner surface thereof and located distant from the first set of holes along a longitudinal axis of the sleeve. The inner surface and the outer surface define a thickness of a wall of the sleeve. The sleeve further defines a plurality of passages within the wall, which extends along the longitudinal axis. Each of the plurality of passages fluidly connects a hole of the first set of holes with a corresponding hole of the second set of holes. Each of the plurality of passages includes a porous medium to increase surface area of each of the plurality of passages. The increased surface area of each of the plurality of passages increases rate of dissipation of heat from the wall of the sleeve.

Other features and aspects of this disclosure will be apparent from the following description and the accompanying drawings.

### BRIEF DESCRIPTION OF THE DRAWINGS

FIG. 1 is a cross-sectional view of a portion of a hydraulic hammer assembly;

FIG. 2 is another cross-sectional view of a portion of the hydraulic hammer assembly of FIG. 1 showing a sleeve; and

FIG. 3 is a sectional view of the sleeve of FIG. 2 having a plurality of passages provided with a porous medium

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in singular may also be construed to relate to the plural and vice-versa without limiting the scope of the disclosure to the exact number or type of such elements unless set forth explicitly in the appended claim.

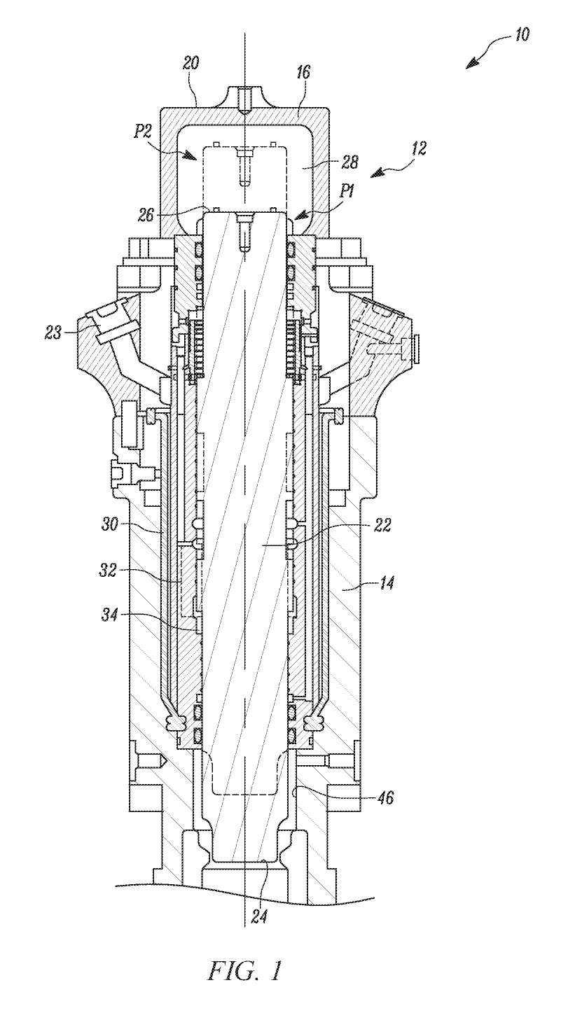

Referring to FIG. 1, a cross-sectional view of a portion of a hydraulic hammer assembly 10 is illustrated. The hydraulic hammer assembly 10 is pivotably connected to a machine not shown). In an example, the machine may be an excavator. In case of the excavator, the hydraulic hammer assembly 10 is pivotably connected to a boom assembly. More specifically, the hydraulic hammer assembly 10 is coupled to a stick of the boom assembly. Further, the hydraulic hammer assembly 10 is fluidly communicated with a hydraulic system of the machine to receive hydraulic fluid therefrom The hydraulic fluid supplied from the hydraulic system is used to operate the hydraulic hammer assembly 10 and hence to break large and hard objects into smaller pieces to assist in easy disposal of such objects from one location to another at a worksite.

The hydraulic hammer assembly 10 includes a housing member (not shown) coupled to the stick of the machine. The housing member is used for accommodating various components, such as a power cell 12 and a work tool (not shown), of the hydraulic hammer assembly 10. The power cell 12 is disposed within the housing member using wear plates. The power cell 12 includes a first housing 14 and a second housing 16 coupled to the first housing 14 using fastening members such as bolts. The first housing 14 defines a first end (not shown) of the power cell 12 and the second housing 16 defines a second end 20 of the power cell 12. The first housing 14 is adapted to slidably receive a piston 22 of the hydraulic hammer assembly 10. More specifically, a portion of the piston 22 is received within the first housing 14. The piston 22 further defines a first end portion 24 received within the first housing 14 and a second end portion 26 received within the second housing 16. The work tool of the hydraulic hammer assembly 10 is also slidably received within the first housing 14 and one end of the work tool is adapted to contact with the first end portion 24 of the piston 22 and another end of the work tool is adapted to engage with a work surface. During operation of the hydraulic hammer assembly 10, reciprocating motion of the piston 22 is transferred to the work tool to vibrate the work tool. The second housing 16 includes multiple ports 23 to fluidly communicate with the hydraulic system of the machine to receive the hydraulic fluid. The hydraulic fluid supplied to the hydraulic hammer assembly 10 is used to cause reciprocating motion of the piston 22. The second housing 16 of the hydraulic hammer assembly 10 defines a chamber 28. The chamber 28 defines a volume which may be varied based on an upward and a downward movement of the piston 22. Also, the chamber 28 is charged with pressurized air and/or gas at a desired pressure before start of the operation of the hydraulic hammer assembly 10.

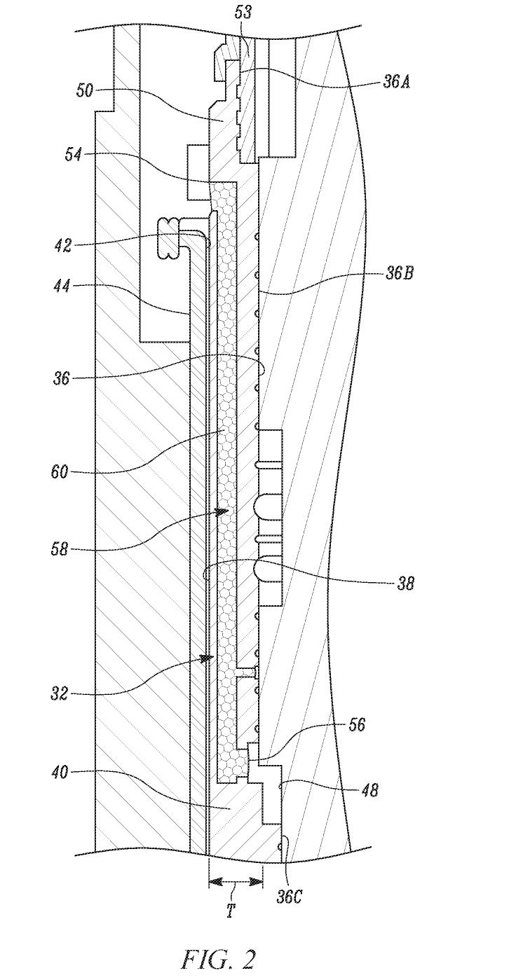

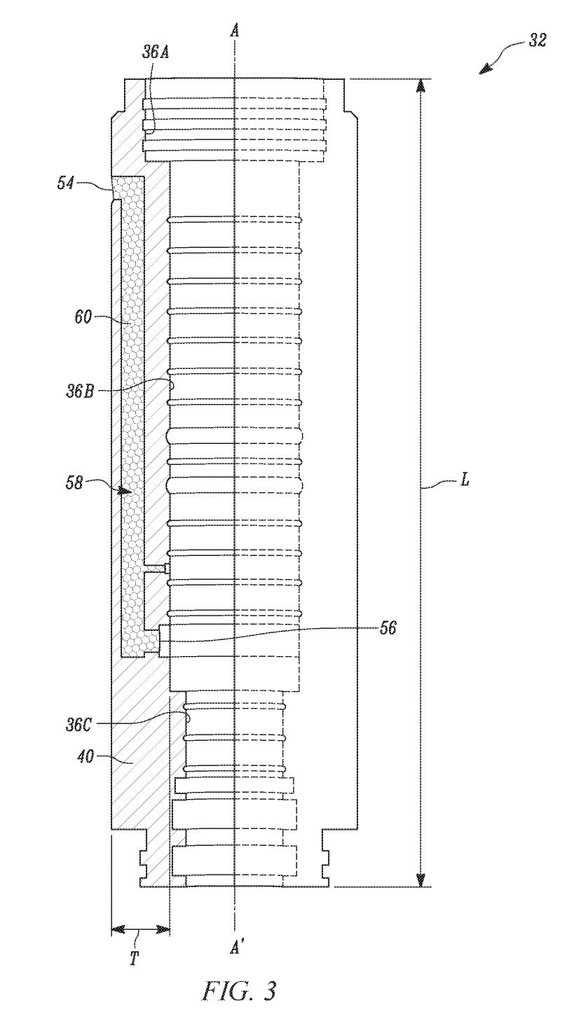

The power cell 12 further includes an accumulator membrane 30 disposed external and coaxial to the piston 22. More specifically, the accumulator membrane 30 is disposed between the piston 22 and the first housing 14. The power cell 12 further includes a sleeve 32 disposed coaxially between the piston 22 and the accumulator membrane 30. In the illustrated embodiment, the sleeve 32 is manufactured as a single component using a Three Dimensional (3D) printing process. In an example, manufacturing of the sleeve 32 using the 3D printing process may involve a 3D printing machine and a software module in communication with the 3D printing machine. The software module may include a CAD model of the sleeve 32. Based on the CAD model of the sleeve 32, the 3D printing machine deposits multiple layers of materials one above another to form the sleeve 32. Construction of the sleeve 32 of the hydraulic hammer assembly 10 is described with respect to FIG. 2 and FIG. 3.

The downward movement of the piston 22 corresponds to a movement of the piston 22 towards a first position ‘P1’ along a vertical direction and the upward movement of the piston 22 corresponds to a movement of the piston 22 towards a second position ‘P2’ along the vertical direction. During operation of the hydraulic hammer assembly 10, the hydraulic system of the machine continues to supply the hydraulic fluid into a bore 34 of the hydraulic hammer assembly 10. As the hydraulic fluid is continuously supplied into the bore 34, pressure of the hydraulic fluid is developed within the bore 34, which then actuates the piston 22 to move from the second position ‘P2’ to the first position ‘P1’. During the upward movement of the piston 22, the second end portion 26 of the piston 22 is received within the chamber 28 and during the downward movement of the piston 22, the first end portion 24 moves out of the chamber 28. The chamber 28 and the piston 22 are arranged in such a manner that the volume of the chamber 28 decreases when the piston 22 moves upward. Decrease in the volume of the chamber 28 may increase pressure of air and/or gas within the chamber 28. Such increase in pressure of the air and/or gas within the chamber 28 facilitates downward movement of the piston 22.

Referring to FIG. 2, another cross-sectional view of a portion of the hydraulic hammer assembly 10 showing the sleeve 32 is illustrated. The sleeve 32 has a circular cross-section and defines an inner surface 36 having multiple diametric portions 36A, 36B, and 36C and an outer surface 38. The inner surface 36 and the outer surface 38 define a thickness ‘T’ of a wall 40 of the sleeve 32. An inner surface 42 of the accumulator membrane 30 defines a clearance with the outer surface 38 of the sleeve 32. Some portion of the hydraulic fluid received through the multiple ports 23 of the second housing 16 is received through the clearance to lubricate various moving components of the hydraulic hammer assembly 10. An outer surface 44 of the accumulator membrane 30 contacts with an inner surface 46 (shown in FIG. 1) of the first housing 14. The inner surface 46 having the multiple diametric portions 36A, 36B, and 36C defines multiple fluid passages with an outer surface 48 of the piston 22. The multiple fluid passages allows flow of the hydraulic fluid received through the multiple ports 23 defined in the second housing 16 to cause movement of the piston 22 in an upward direction.

The sleeve 32 includes a first end portion 50 and a second end portion 52 (shown in FIG. 1) received within the first housing 14. A valve member 53 of the hydraulic hammer assembly 10 is received within the second housing 16 and disposed adjacent to the first end portion 50 of the sleeve 32. The sleeve 32 defines a first set of holes 54 in the outer surface 38 to fluidly communicate with the multiple ports 23 defined in the second housing 16. As such, the first set of holes 54 receives the hydraulic fluid received through the multiple ports 23. More specifically, the first set of holes 54 are located proximal to the first end portion 50 of the sleeve 32 and along an annular periphery thereof. Each of the first set of holes 54 is further defined as a blind hole having a depth less than the thickness ‘T’ of the wall 40 of the sleeve 32. Each of the first set of holes 54 is further defined along a radial axis perpendicular to a longitudinal axis A-A′ of the sleeve 32. In an example, each of the first set of holes 54 may be inclined at an angle with respect to the longitudinal axis A-A′ of the sleeve 32. The sleeve 32 further defines a second set of holes 56 in the inner surface 36. The second set of holes 56 allows flow of fluid into the bore 34 of the sleeve 32. The second set of holes 56 is located distant from the first set of holes 54 along the longitudinal axis A-A′ defined by the sleeve 32. The second set of holes 56 are located proximal to the second end portion 52 of the sleeve 32 and along the annular periphery of the sleeve 32. Each of the second set of holes 56 is further defined as a blind hole having a depth less than the thickness ‘T’ of the wall 40 of the sleeve 32. Each of the second set of holes 56 is further defined along a radial axis perpendicular to the longitudinal axis A-A′ of the sleeve 32. The sleeve 32 further defines a plurality of passages 58 within the wall 40, which extends along the longitudinal axis A-A′ to fluidly communicate with the first set of holes 54 and the second set of holes 56. Particularly, the plurality of passages 58 allows flow of fluid from the first set of holes 54 to the second set of holes 56, and hence to allow the hydraulic fluid to the bore 34 of the sleeve 32. The plurality of passages 58 extends along a portion of a length of the sleeve 32. Each of the plurality of passages 58 fluidly connects a hole of the first set of holes 54 with a corresponding hole of the second set of holes 56. Each of the plurality of passages 58 has a circular or a rectangular cross section and has a diameter or a depth, respectively, less than the thickness ‘T’ of the wall 40 of the sleeve 32. Hydraulic fluid flows from the first set of holes 54 through each of the plurality of passages 58 to the second set of holes 56 within the sleeve 32.

Referring to FIG. 3, a sectional view of the sleeve 32 of FIG. 2 having the plurality of passages 58 provided with a porous medium 60 is illustrated. More particularly, each of the plurality of passages 58 is defined my multiple small voids to form a porous structure and hence to allow the flow of hydraulic fluid therethrough The porous structure, in the illustrated embodiment, is a honeycomb structure used to increase surface area of each of the plurality of passages 58. The increased surface area of each of the plurality of passages 58 increases rate of dissipation of heat, generated during the operation of the hydraulic hammer assembly 10, from the wall 40 of the sleeve 32. In operation, the hydraulic system of the machine supplies hydraulic fluid to the hydraulic hammer assembly 10 through the first set of holes 54. More specifically, the hydraulic fluid enters the first set of holes 54 defined in the outer surface 38 of the sleeve 32. Upon the hydraulic fluid is received in the first set of holes 54, the fluid is then transferred to the second set of holes 56 through the plurality of passages 58. The hydraulic fluid flows through the porous medium 60 of each of the plurality of passages 58. As such, heat generated during the operation of the hydraulic hammer assembly 10 is dissipated through the porous medium 60 as the porous structure increases the surface area to be in contact with the hydraulic fluid passing through each of the plurality of passages 58. In an example, the porous medium 60 may be any structure that can be adapted to increase surface area in each of the plurality of passages 58. The porous medium 60, apart from increasing surface area in each of the plurality of passages 58, facilitates heat dissipation during operation of the hydraulic hammer assembly 10. The sleeve 32 having the porous structure is manufactured using the 3D printing process. Various dimensional aspects, such as the inner surface 36 having the multiple diametric portions 36A, 36B, and 36C, the outer surface 38, the first set of holes 54, the second set of holes 56, and the plurality of passages 58 with the porous structure of the sleeve 32 are precisely and accurately formed by the 3D printing process.

The sleeve 32 further defines at least one fluid redirection passage (not shown) and at least one fluid return passage (not shown) within the wall 40 thereof. The fluid redirection passage is used for causing upward movement of the piston 22 and the fluid return passage is in fluid communication with the hydraulic system of the machine to drain the hydraulic fluid from the hydraulic hammer assembly 10 to a reservoir of the hydraulic system In another embodiment, the fluid redirection passage and the fluid return passage may also be provided with the porous medium 60.

### INDUSTRIAL APPLICABILITY

The present disclosure relates to the hydraulic hammer assembly 10 having the 3D printed sleeve. The sleeve 32 along with the various features, such as the plurality of passages 58 with the porous medium 60, of the hydraulic hammer assembly 10 is manufactured using the 3D printing process in such a way that the sleeve 32 is capable of dissipating heat generated during the operation of the hydraulic hammer assembly 10 at a taster rate compared to a known sleeve. The porous medium 60 is provided along each passage of the plurality of passages 58 in the sleeve 32. Owing to the increased surface area and the structure of the porous medium 60 within each passage of the plurality of passages 58, heat generated during the operation of the hydraulic hammer assembly 10 is dissipated fast. Due to the presence of the porous medium 60 within the sleeve 32, heat, which otherwise retained within a wall of the sleeve 32 for a longer period due to a thick section of the wall 40, may be dissipated fast to avoid any premature failure of the sleeve 32. Any type of porous structure may be manufactured within the wall 40 or the outer surface 38 of the sleeve 32 using the 3D printing process to define the plurality of passages 58.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hydraulic hammer assembly comprising:
a piston;
an accumulator membrane disposed external and coaxial to the piston; and
a sleeve disposed coaxially between the piston and the accumulator membrane, the sleeve defining:
a first set of holes in an over surface thereof to receive hydraulic fluid;
a second set of holes in an inner surface thereof and located distant from the first set of holes along a longitudinal axis of the sleeve, wherein the inner surface and the outer surface define a thickness of a wall of the sleeve; and
a plurality of passages within the wall, the plurality of passages extending along the longitudinal axis, each of the plurality of passages fluidly connecting a hole of the first set of holes with a corresponding hole of the second set of holes,
wherein each of the plurality of passages includes a porous medium to increase surface area of each of the plurality of passages, and wherein the increased surface area of each of the plurality of passages increases rate of dissipation of heat from the wall of the sleeve.

2. The hydraulic hammer assembly of claim 1, wherein the sleeve is a three-dimensional printed sleeve.
